(19) United States
(12) Patent Application Publication
(10) Pub. No.: US 2015/0248167 A1
(43) Pub. Date: Sep. 3, 2015

(54) CONTROLLING A COMPUTING-BASED DEVICE USING GESTURES

(71) Applicant: Microsoft Corporation, Redmond, WA (US)

(72) Inventors: Henrik Turbell, Stockholm (SE); Mattias Nilsson, Sundbyberg (SE); Renat Vafin, Tallinn (EE); Jekaterina Pinding, Tallinn (EE); Antonio Criminisi, Cambridge (UK); Indeera Munasinghe, Cambridge (UK)

(73) Assignee: Microsoft Corporation, Redmond, WA (US)

(21) Appl. No.: 14/242,649

(22) Filed: Apr. 1, 2014

(30) Foreign Application Priority Data
Feb. 28, 2014 (GB) 1403586.9

(51) Int. Cl. G06F 3/01; H04N 7/15; G06F 3/0481

(52) U.S. Cl. CPC G06F 3/017; G06F 3/0481; H04N 7/15

(57) ABSTRACT

Methods and systems for controlling a computing-based device based on gestures made within a predetermined range of a camera wherein the predetermined range is a subset of the field of view of the camera. Any gestures made outside of the predetermined range are ignored and do not cause the computing-based device to perform any action. In some examples, the gestures are used to control a drawing canvas that is implemented in a video conference session. In these examples, a single camera may be used to generate an image of a video conference user which is used to detect gestures in the predetermined range and provide other parties to the video conference session a visual image of the user.

### RELATED APPLICATIONS

This application claims priority under 35 USC §119 or §365 to Great Britain Patent Application No. 1403586.9 entitled “CONTROLLING A COMPUTING-BASED DEVICE USING GESTURES” filed Feb. 28, 2014 by Turbell et al., the disclosure of which is incorporate in its entirety.

### BACKGROUND

There has been significant research over the past decades on Natural User Interfaces (NUI). NUI includes new gesture-based interfaces that use touch or touch-less interactions or the full body to enable rich interactions with a computing device. In traditional NUI systems one or more cameras are used to capture images of a user to detect and track the user's body parts (e.g. hands, fingers) to identify gestures performed by the detected body parts. Any detected gestures may then be used to control a computing device.

The embodiments described below are not limited to implementations which solve any or all of the disadvantages of known systems for controlling computing devices.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Methods and systems for controlling a computing-based device based on gestures made within a predetermined range of a camera wherein the predetermined range is a subset of the field of view of the camera. Any gestures made outside of the predetermined range are ignored and do not cause the computing-based device to perform any action. In some examples, the gestures are used to control a drawing canvas that is implemented in a video conference session. In these examples, a single camera may be used to generate an image of a video conference user which is used to detect gestures in the predetermined range and provide other parties to the video conference session a visual image of the user.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a system for controlling a computing-based device using gestures;

FIG. 2 is a block diagram of an example capture device and an example computing-based device of FIG. 1;

FIG. 3 is a schematic diagram of the predetermined range of FIG. 1;

FIG. 4 is a flow diagram of an example method for detecting a gesture using the system of FIG. 1;

FIG. 5 is a schematic diagram of a virtual canvas;

FIG. 6 is a block diagram of an example computing-based device to generate a virtual canvas which may be controlled using the output of the system of FIG. 1;

FIG. 7 is a series of schematic diagrams illustrating the location of the virtual canvas of FIG. 5;

FIG. 8 is a series of schematic diagrams illustrating the virtual canvas of FIG. 5 appearing on the user's display;

FIG. 9 is a series of schematic diagrams illustrating generation of drawing elements on the virtual canvas of FIG. 5;

FIG. 10 is a series of schematic diagrams illustrating a condensation effect on the virtual canvas of FIG. 5;

FIG. 11 is a series of schematic diagrams illustrating a kiss effect on the virtual canvas of FIG. 5; and

FIG. 12 is a block diagram of an exemplary computing-based device in which embodiments of the control system and/or methods may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

As described above, in traditional NUI systems one or more cameras are used to capture images of a user to detect and track the user's body parts (e.g. hands, fingers) to identify gestures performed by the detected body parts. Any detected gestures may then be used to control a computing device. However, such systems may detect other objects in the field of view of the camera which may be misinterpreted as a user's body part which may cause an erroneous gesture to be detected. This is a particular problem in video conferencing systems where there may be activity taking place behind the user or party to the video conference that is within the field of view of the camera or the user himself/herself may be performing an activity, such as using a touch screen of the computing device, that is not intended to be used as a gesture input. This activity can (a) be improperly identified as gesture inputs that may cause the computing device to execute commands that were not intended; and (b) waste resources used to identify and track objects that are not relevant inputs. Accordingly there is a need to control the area analyzed for relevant objects.

Described herein are systems and methods for controlling a computing-based device using gestures executed only within a predetermined range (i.e. three-dimensional volume) of a capture device wherein the predetermined range is a subset of the field of view of the capture device. The term subset is used herein to mean a part of an item and does not include the entire item. The system receives an image stream of a scene from the capture device which it analyzes to identify objects in the scene that are within the predetermined range. Once the system has identified objects within the predetermined range it tracks the objects to determine the location and/or motion of the objects within the predetermined range and to identify any gestures performed by the objects. The determined locations and identified gestures can then be used to control a computing-based device.

In some cases the location and gesture information may be used to control a video conferencing application. In particular, the location and gesture information may be used to control a drawing canvas within a video conferencing application. In these cases the capture device may comprise a single camera that is used to generate a single image stream of the user. This single image stream may be used to both (a) identify objects and detect gestures; and (b) provide other parties to the video conference with a visual image of the user.

As described above, by limiting the area in which a gesture can be made, the number of erroneously identified gestures that can cause the computing-based device to execute a command that was not intended is reduced (thus making the gesture recognition more robust); and resources are not wasted identifying and tracking objects that are not relevant inputs.

Although the present examples are described and illustrated herein as being implemented in a video conferencing system, the system described is provided as an example and not a limitation. As those skilled in the art will appreciate, the present examples are suitable for application in a variety of different systems.

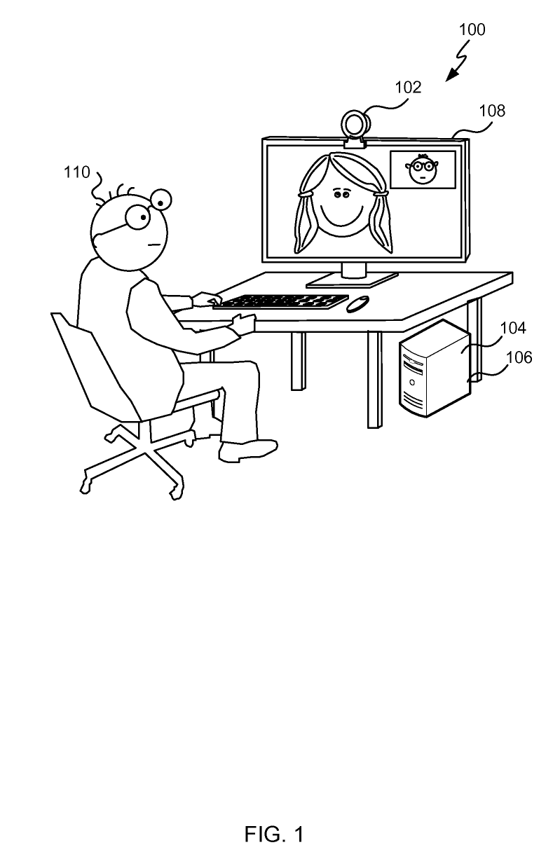

Reference is first made to FIG. 1, which illustrates an example system 100 for controlling a computing-based device 104 using gestures executed in a predetermined range within the field of view of a capture device 102.

The computing-based device 104 shown in FIG. 1 is a traditional desktop computer with a separate processor component 106 and display screen 108; however, the methods and systems described herein may equally be applied to computing-based devices 104 wherein the processor component 106 and display screen 108 are integrated such as in a laptop computer or a tablet computer.

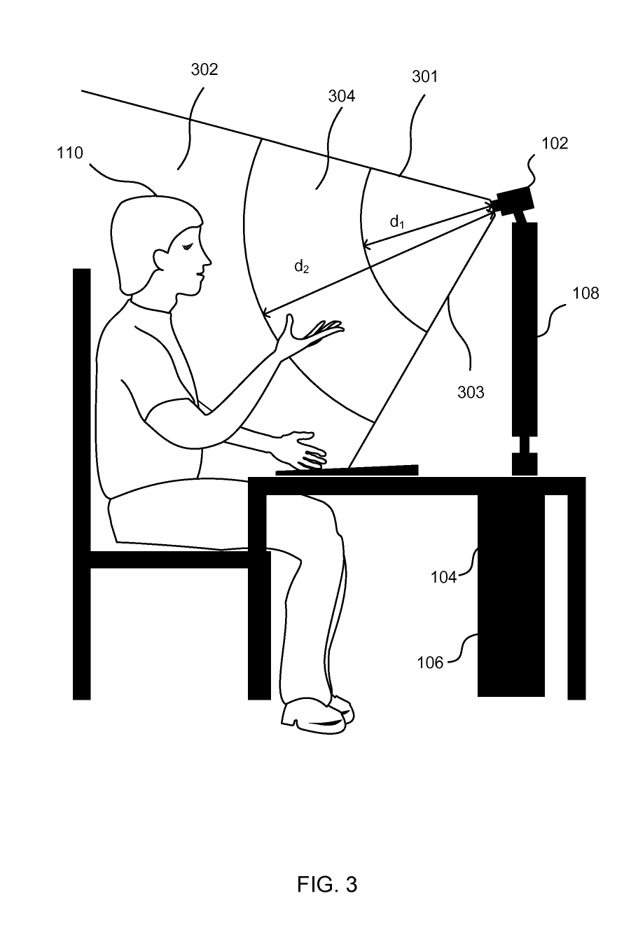

The capture device 102 generates images of a scene which are interpreted or analyzed by either the capture device 102 or the computing-based device 104 to detect gestures made in a predetermined range within the field of view of the capture device 102. The predetermined range is described in more detail with reference to FIG. 3. Detected gestures in the predetermined range can then be used to control the operation of the computing-based device 104. Although the system 100 of FIG. 1 comprises a single capture device 102, the methods and principles described herein may be equally applied to control systems with multiple capture devices 102.

In FIG. 1, the capture device 102 is mounted on top of the display screen 108 and pointing towards the user 110. However, in other examples, the capture device 102 may be embedded within or mounted on any other suitable object in the environment (e.g. within display screen 108).

In operation, an object (e.g. a user's face or hands) can be tracked using the images generated by the capture device 102 such that the position and movement of the object can be interpreted by the capture device 102 or the computing-based device 104 as performing gestures that can be used to control an application being executed by or displayed on the computing-based device 104.

The system 100 may also comprise other input devices, such as a keyboard or mouse, in communication with the computing-based device 104 that allow a user to control the computing-based device 104 through traditional means.

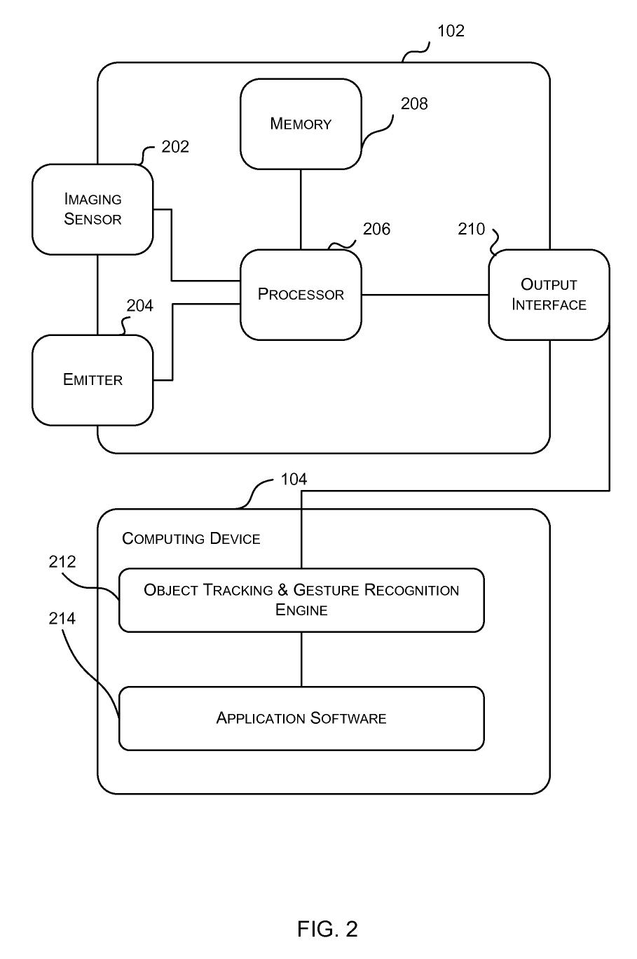

Reference is now made to FIG. 2, which illustrates a schematic diagram of a capture device 102 that may be used in the system 100 of FIG. 1. The capture device 102 comprises at least one imaging sensor 202 for capturing images of the scene. The imaging sensor 202 may be a depth camera arranged to capture depth information of the scene. The depth information may be in the form of a depth image that includes depth values, i.e. a value associated with each image element (e.g. pixel) of the depth image that is related to the distance between the depth camera and an item or object located at that image element.

The depth information can be obtained using any suitable technique including, for example, time-of-flight, structured light, stereo image, or the like.

The captured depth image may include a two dimensional (2-D) area of the captured scene where each image element in the 2-D area represents a depth value such as length or distance of an object in the captured scene from the imaging sensor 202.

In some cases, the imaging sensor 202 may be in the form of two or more physically separated cameras that view the scene from different angles, such that visual stereo data is obtained that can be resolved to generate depth information.

The capture device 102 may also comprise an emitter 204 arranged to illuminate the scene in such a manner that depth information can be ascertained by the imaging sensor 202.

The capture device 102 may also comprise at least one processor 206, which is in communication with the imaging sensor 202 (e.g. depth camera) and the emitter 204 (if present). The processor 206 may be a general purpose microprocessor or a specialized signal/image processor. The processor 206 is arranged to execute instructions to control the imaging sensor 202 and emitter 204 (if present) to capture image information that comprises depth information or comprises information that can be used to generate depth information. The processor 206 may optionally be arranged to perform processing on these images and signals, as outlined in more detail below.

The capture device 102 may also include memory 208 arranged to store the instructions for execution by the processor 206, images or frames captured by the imaging sensor 202, or any suitable information, images or the like. In some examples, the memory 208 can include random access memory (RAM), read only memory (ROM), cache, Flash memory, a hard disk, or any other suitable storage component. The memory 208 can be a separate component in communication with the processor 206 or integrated into the processor 206.

The capture device 102 may also include an output interface 210 in communication with the processor 206. The output interface 210 is arranged to provide data to the computing-based device 104 via a communication link. The communication link can be, for example, a wired connection (e.g. USB™, Firewire™, Ethernet™ or similar) and/or a wireless connection (e.g. WiFi™, Bluetooth™ or similar). In other examples, the output interface 210 can interface with one or more communication networks (e.g. the Internet) and provide data to the computing-based device 104 via these networks.

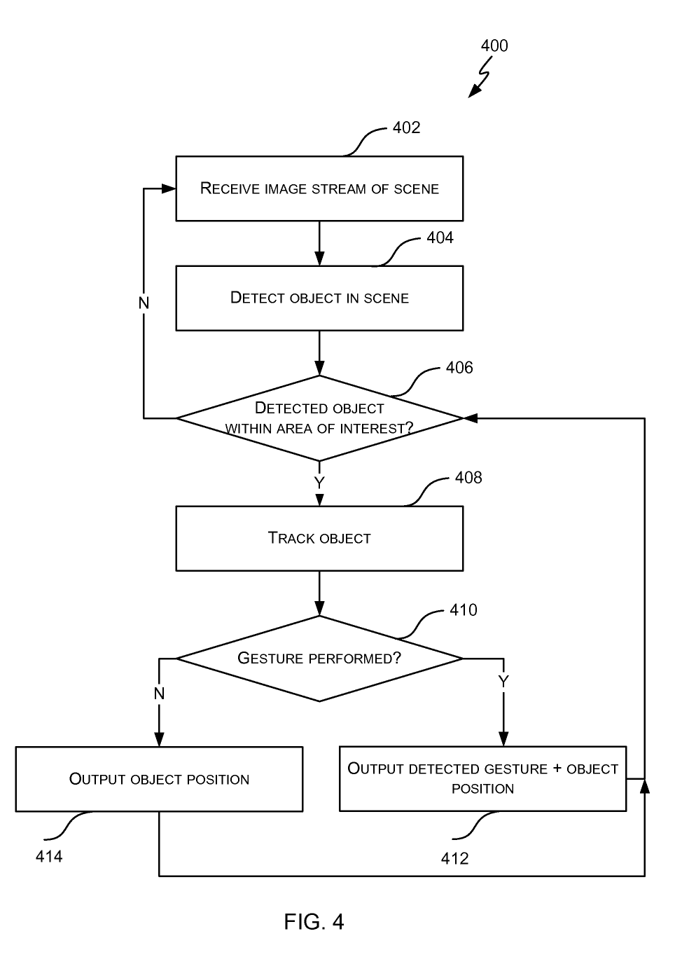

The computing-based device 104 may comprise an object tracking and gesture recognition engine 212 that is configured to execute one or more functions related to object tracking and/or gesture recognition. Example functions that may be executed by the object tracking and gesture recognition engine 212 are described with reference to FIG. 4. For example, the object tracking and gesture recognition engine 212 may be configured to identify certain objects (e.g. a user's face, hands and/or fingers) in an image. Once an object has been identified the gesture recognition engine 212 uses the depth information associated with the image elements forming the objects to determine if the object is in a predetermined range of the capture device 102. If the object is determined to be in the predetermined range the object is tracked to determine the location and/or motion of the object and to determine if a gesture is performed or executed by the object. If the object is not determined to be in the predetermined range then the object is not tracked and gestures are not detected. Therefore objects outside of the predetermined range do not cause a gesture to be output by the object tracking and gesture recognition engine 212 even if a gesture is performed or executed by the object.

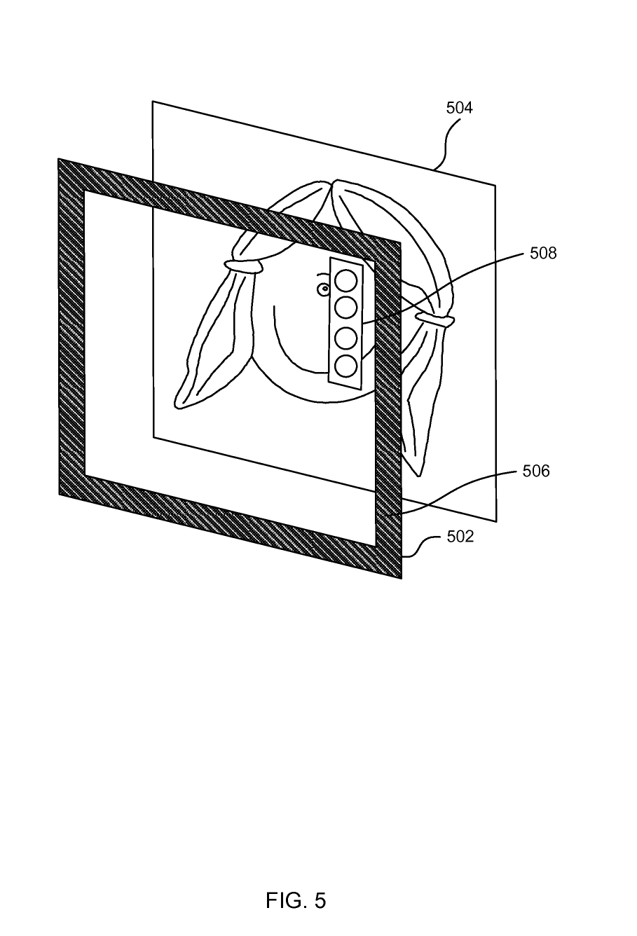

Application software 214 may also be executed on the computing-based device 104 and controlled using the output of the object tracking and gesture recognition engine 212 (e.g. the position of the objects in the predetermined range and any detected gestures executed in the predetermined range). For example, in some cases the application software 214 may be a video conferencing application which may be controlled using gestures performed by a user in the predetermined range. In particular, in some examples, the output of the object tracking and gesture recognition engine 212 may be used to control a drawing canvas used in a video conference session. This will be described in more detail with reference to FIGS. 5 to 11.

Reference is now made to FIG. 3 which illustrates the predetermined range used by the system 100 of FIG. 1. The capture device 102 has a field of view (FOV) 302 which is the area of the scene that is visible to the capture device 102. In FIG. 3 the FOV 302 is the area between lines 301 and 303. Typically when the capture device 102 generates an image it includes a representation of all of the items or objects within the FOV 302. As described above, the system 100 of FIG. 1 is used to detect objects within, and gestures executed in, a predetermined range 304 within the FOV 302.

The predetermined range 304 is a subset or portion of the FOV 302 that is spaced from (i.e. not adjacent to, or distant to) the capture device 102. In some cases the predetermined range 304 is a three-dimensional volume. For example the predetermined range 304 may be a three-dimensional volume defined by two distances, d₁ and d₂, where d₁ is a first distance from the capture device 102 and d₂ is a second distance from the capture device where d₁ is less than d₂. In these examples, the predetermined range 304 encompasses anything that has a distance from the capture device 102 that is between d₁ and d₂.

In some examples the predetermined range 304 is fixed, hardcoded or predefined (e.g. d₁ and d₂ are hardcoded in the application). In other examples, the predetermined range 304 may be dynamically selected. For example, in some cases users may execute a calibration procedure which is designed to select an appropriate predetermined range. In other cases, the system 100 may be configured to automatically select a suitable predetermined range based on, for example, the location of the user's head.

As shown in FIG. 3, in some cases, d₁ and d₂ may be fixed or dynamically selected so that the predetermined range 304 is a mid-range between the user 110 and the capture device 102. Where the output of the object tracking and gesture recognition engine 212 is used to control a drawing canvas of a video conference application (as described in detail below) defining the predetermined range 304 as a mid-range between the user 110 and the capture device 102 allows the system to ignore movement by the user that is not intended as a controlling gesture (e.g. movements close to the user's body) and movement by the user that is intended to interact with the computing-based device 104 in another manner (e.g. by interacting with a touch screen). This would, for example, allow the user to both (i) interact to interact with a touch-screen associated with the computing-based device 104 to control aspects of the video conferencing application (e.g. ending or starting a call) without causing a change to the drawing canvas; and (ii) to edit drawings in the drawing canvas using gestures made in the predetermined range 304.

The predetermined range 304 may be the same for all applications running on the computing-based device 104, or may be different for different applications. As an example, a predetermined range 304 defined by a first distance d₁ around 0.1 m and a second distance d₂ around 0.4 m has proven to work well for some applications, such as video conferencing applications.

Reference is now made to FIG. 4 which illustrates a method 400, which may be executed by the object tracking and gesture recognition engine 212 of FIG. 2, for detecting gestures performed in the predetermined range 304. At block 402, the object tracking and gesture recognition engine 212 receives a stream of images (e.g. a video stream) of a scene from the capture device 102. The stream of images comprises depth information or information from which depth information can be obtained. For example, depth information may be obtained from an RGB image stream using the method outlined in the U.S. patent application entitled “DEPTH SENSING USING AN RGB CAMERA” which was filed by the Applicants on the same day as this application.

As described in the “DEPTH SENSING USING AN RGB CAMERA” patent application, depth information may be obtained from an RGB image by applying the RGB image to a trained machine learning component to produce a depth map. The depth map comprises a depth value for each image element of the RGB image which represents the absolute or real world distance between the surface represented by the image element in the RGB image and the RGB camera.

In some examples the trained machine learning component may comprise one or more random decision forests trained using pairs of RGB images and corresponding ground truth depth maps. The pairs of RGB images and depth maps may be generated from a real physical setup (e.g. using a RGB camera and a depth camera). The pairs of RGB images and depth maps may also, or alternatively, be synthetically generated using computer graphics techniques. In other examples, other suitable machine learning components may be used such as, but not limited to, a deep neural network, a support vector regressor, and a Gaussian process regressor.

Once the image stream has been received, the method 400 proceeds to block 404.

At block 404, the object tracking and gesture recognition engine 212 analyzes the image stream to detect objects within the scene. In some cases the object tracking and gesture recognition engine 212 may be configured to detect only a predefined list of objects, such as the face, hands and/or fingers of a user. Any known method for detecting objects in an image may be used, such as, but not limited to correlation or a machine learning method (e.g. a decision forest) Once the tracking and gesture recognition engine 212 has detected an object in the image stream, the method 400 proceeds to block 406.

At block 406, the object tracking and gesture recognition engine 212 determines whether the object or objects identified in block 404 are within the predetermined range 304 of the FOV 302. In some cases, the object tracking and gesture recognition engine 212 may determine that an object is within the predetermined range 304 if the image elements associated with that object have a depth value in the specified range (e.g. d₁<depth value<d₂). In some cases the object tracking and gesture recognition engine 212 may be configured to compare the average or mean of the depth values associated with the image elements forming the identified object with the maximum and minimum depth values (d₂ and d₁). As described above, the depth values associated with the image elements may be generated by the capture device 102 (e.g. where the capture device 102 is a depth camera) or may be generated by the image information generated by the capture device (e.g. from the R, G, B values of an RGB image using the DEPTH SENSING USING AN RGB IMAGE method described above).

If it is determined that at least one of the identified objects is within the predetermined range 304, the method 400 proceeds to block 408. If, however, none of the identified objects are within the predetermined range 304, the method 400 proceeds back to block 402.

At block 408, the object tracking and gesture recognition engine 212 tracks the objects in the predetermined range 304 to determine their location and/or shape to identify gestures performed by the objects. In some cases the object tracking and gesture recognition engine 212 monitors the objects identified in blocks 404 and 406 to assign the objects state and part labels which may be used to identify gestures. For example, the object tracking and gesture recognition engine 212 may be configured to identify parts of the objects (e.g. for a hand, the object tracking and gesture recognition engine 212 may be configured to assign each image element of the hand a part label that identifies for example, the palm, fingers and/or thumb) and the state or position of the object (e.g. for a hand, the object tracking and gesture recognition engine 212 may be configured to assign each image element of the hand a state label that identifies if the hand is open/closed; palm up/down and/or pointing/not pointing). In these cases the state and/or part labels may be defined by hand or learned using machine learning. The method 400 then proceeds to block 410.

At block 410, the object tracking and gesture recognition engine 212 determines whether any of the identified objects has executed or performed one of a predetermined set of gestures. In cases where the tracked object is assigned state and/or state labels, detecting that an object has executed or performed one of a predetermined set of gestures may comprise determining whether the object has had a series of part/state combinations over a number of sequential images. In other cases detecting that an object has executed or performed a gesture may be based on the amount of motion of the object. For example, a pen down gesture (i.e. start drawing gesture) may be detected when the object tracking and gesture recognition engine 212 determines that the object (e.g. user's finger) has stopped moving or has very little motions; and a pen up gesture (i.e. stop drawing gesture) may be detected when the object tracking and gesture recognition engine detects that the object (e.g. user's finger) has moved quickly away from the capture device 102.

If it has been determined that at least one of the objects has executed or performed one of the gestures in the predetermined set of gestures, the method 400 proceeds to block 412 where the location of the object and the detected gesture is output. The detected gesture may then be passed to another application which uses it to control the operation of the application. For example, the detected gestures may be used to control the operation of a video conferencing application and/or an operating system. Where, however, it has been determined that none of the objects have executed or performed one of the predetermined gestures then the method 400 proceeds to block 414 where only the location of the object is output. After the location and/or detected gesture is output, the method 400 proceeds back to block 406.

In some cases, the object tracking and gesture recognition engine 212 may only output gesture information. This may be used for applications where it is not relevant to know where within the predetermined range 304 the gesture was performed. In some cases the object tracking and gesture recognition engine 212 may be configured to also output the detected motion of the object. In other cases (as described above) the motion information may be used to detect whether a gesture has been performed and thus is incorporated into the gesture output.

In some cases, once the object tracking and gesture recognition engine 212 has detected an object in the predetermined range 304, the object tracking and gesture recognition engine 212 may determine the speed at which the object entered the predetermined range 304. If the initial entry speed is above a first predetermined threshold, the object tracking and gesture recognition engine 212 may only identify and/or output gestures performed by the identified object in the predetermined range once the speed of the object drops below a second predetermined threshold. Accordingly, any gesture performed by an object that enters the predetermined range at a quick speed is ignored and is not used to control the computing-based device until the object slows down.

Although method 400 has described executing aspects of the method in a certain order, in other examples aspects of the method may be executed in another suitable order. For example, in some cases the object tracking and gesture detection engine 212 may be configured to first analyze the depth information and only analyze those image elements of the images generated by the capture device 102 that have a depth within the predetermined range (i.e. has a depth value in the specified range (e.g. d₁<depth value<d₂)) to identify objects and gestures performed by those objects.

The order in which the aspects of the method 400 are executed may be based on the hardware used in the system 100. For example, if the capture device 102 comprises a depth camera that generates depth maps the system 100 may be designed to discard image elements of the image that are outside the predetermined range 304 and then perform tracking and gesture recognition on only those image elements within the predetermined range 304. Alternatively, if the capture device 102 comprises an RGB camera that generates RGB images from which depth information can be obtained, the system 100 may be configured to first analyze the RGB image to identify objects and gestures performed by the identified objects and then perform depth thresholding on the identified objects. In these cases characteristics of the identified objects (e.g. size of a detected hand, finger or face) may be used to aid in determining the depth of the objects.

In some cases the location and gesture information output by the methods and systems described above is used to control a virtual and transparent drawing canvas which allows the user to create drawing elements. Reference is now made to FIG. 5 which illustrates a virtual transparent drawing canvas 502 that may be controlled by the gestures output by the methods and systems described above. Because the drawing canvas 502 is transparent it may be overlaid another image or video stream 504. This allows the user to create drawing elements and other image effects that are displayed in front of or on top of the other image or video stream 504.

Where the virtual transparent drawing canvas 502 is used in a video conferencing system or application, the virtual transparent drawing canvas 502 may be displayed in front of the received image or video stream (i.e. the image or video stream of another party to the video conference), the transmitted image or video stream (i.e. the image or video stream of the user), part of the received or transmitted image or video stream, or both the received and transmitted image. In these cases the drawing canvas 502 may be configured to simulate a real physical window between the parties to the video conference which may be controlled and/or modified by one or more than one party. In some cases the capture device 102 comprises a single camera which is used to capture a single image stream of the user. The single image stream is used to both detect objects and gestures in the predetermined range and to provide other parties to the video conference with an image of the user.

In some cases the virtual transparent drawing canvas 502 may comprise a border or the like 506 that makes the user aware that the drawing canvas 502 is active or is currently being displayed. Where the drawing canvas 502 is configured to simulate a real physical window the border 502 may, for example, be rendered to resemble the edges of a physical glass window. The border 502 may also or alternatively be configured to resemble frosting.

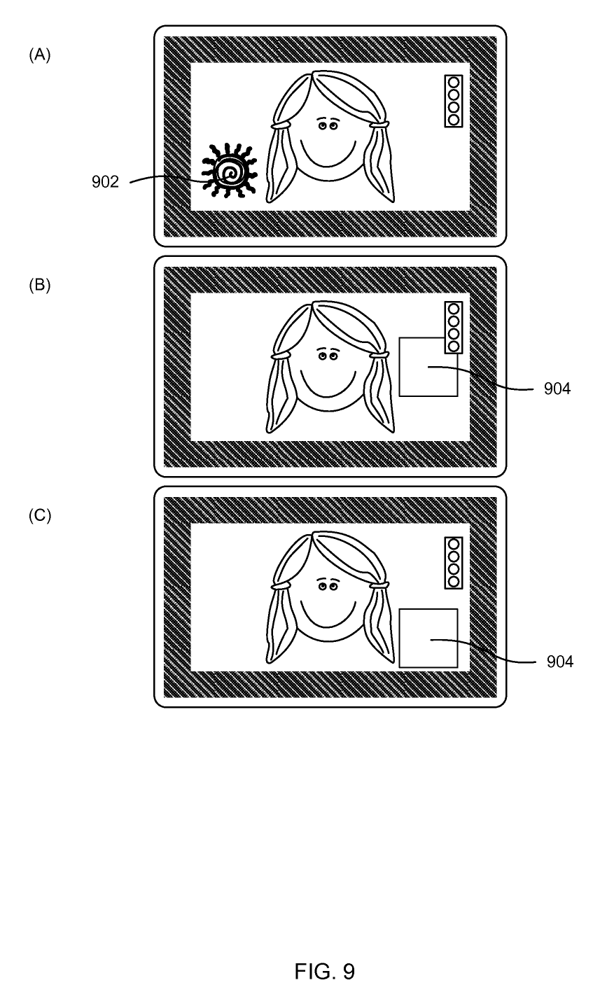

The virtual transparent drawing canvas 502 may also comprise a drawing toolbar 508 that allows the user to select from and/or activate drawing tools. For example, the drawing toolbar 508 may allow the user to select from a number of shapes, colors, line thicknesses, manipulation tools etc. The drawing toolbar 508 may permanently appear on the drawing canvas 502 or may be activated and/or deactivated upon receiving certain inputs (e.g. gestures). The use of such a drawing toolbar 508 will be described in more detail with reference to FIG. 9.

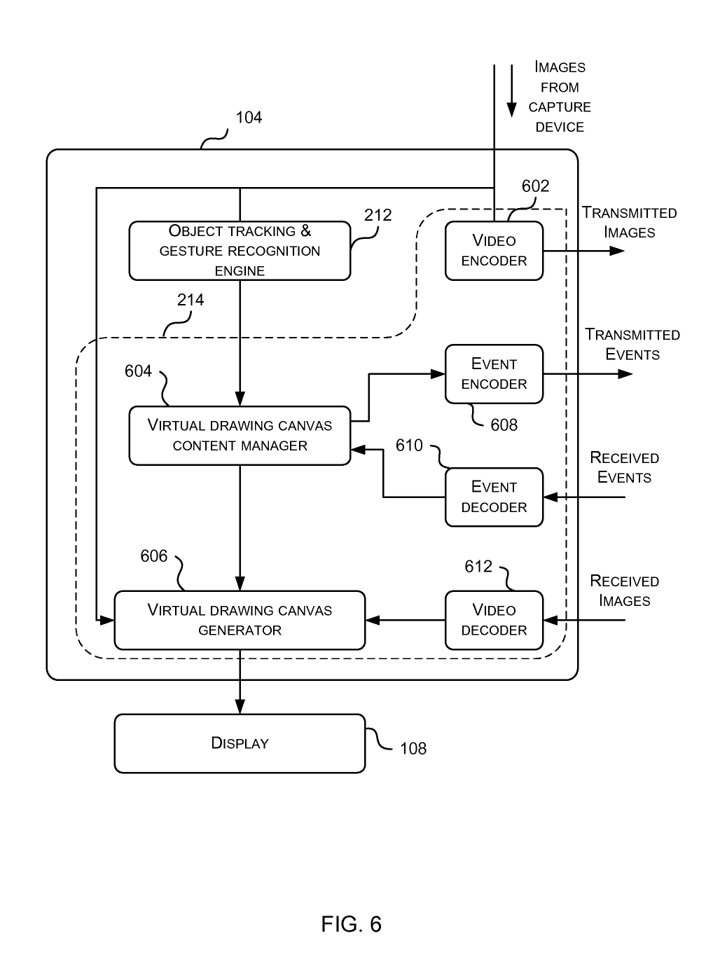

Reference is now made to FIG. 6 which illustrates an example computer-based device 104 that is configured to control a transparent drawing canvas 502 in a video conferencing system or application using the gesture recognition system and methods described above. In this example, the computer-based device 104 comprises the object tracking and gesture recognition engine 212 of FIG. 2 which may be configured to execute the method 400 of FIG. 4 to analyze the images received from the capture device 102 to identify gestures performed by the user 110 in a predetermined range 304 of the FOV 302 of the capture device 102. In this example, the object tracking and gesture recognition engine 212 may be configured to recognize and track the face, hands and/or fingers of the user 110 to identify gestures performed by the user's face, hands and/or fingers.

As described above, in some cases the same image stream used by the object tracking and gesture recognition engine 212 to detect gestures is also used to provide the other parties to the video conference an image of the user 110. In these cases the image stream generated by the capture device 102 may be provided to a video encoder 602. The video encoder 602 encodes the received images using a suitable video codec and then transmits the encoded images via, for example, a data communications network to the other party/parties. The receiving computing-based device decodes the received encoded images and displays the decoded images to the receiving party. The images of the user 110 that are transmitted to the other parties to the video conference are referred to herein as the transmitted images.

A virtual drawing canvas content manager 604 receives the output of the object tracking and gesture recognition engine 212 and determines what action, if any, should be performed on the drawing canvas 502, based on the received object location and gesture information. For example, the content manager 604 may keep track of the state of the drawing canvas 502 and compare the received object location and gesture information against the state of the drawing canvas 502 to determine if the object location and gesture information received from the object tracking and gesture recognition engine 212 causes an action to be performed on the drawing canvas. If the content manager 604 determines that an action should be performed on the drawing canvas 502, the content manager 604 sends an event to a virtual drawing canvas generator 606 to implement the action, and to an event encoder 608 for encoding the event and transmitting the encoded event to the other parties to the video conference so the action can be implemented on the other parties displays as well. An event may include one or more of the following: gesture name, object (e.g. hand, face, finger) three dimensional (3D) position(s) and/or angle(s), corresponding position(s) and angle(s) projected down onto the 2D image, 2D and 3D motion information, strength (e.g. mouth openness), time stamp, confidence value (indicating how well it was detected).

Where the drawing canvas 502 can be modified by any party to the video conference, the virtual drawing canvas content manager 604 may also receive event information from the other users/parties to the video conference via an event decoder 610. The event decoder 610 receives an encoded event from one of the other parties to the video conference, decodes the received event and provides the decoded event to the content manager 604. In these cases, the event information may comprise timestamp information that allows the events to be synchronized with the video at the receiver end.

The virtual drawing canvas generator 606 receives the images of the user generated by the capture device 102, images of the other party/parties to the video conference, and the event information generated by the content manager 604 and uses this information to generate a complete image that is displayed to the user. The complete image comprises a rendered drawing canvas which incorporates or implements the actions identified by the events received from the content manager 604 merged with the image or video stream of the other party/parties (i.e. the received image or video stream) and/or the image of the user (i.e. the transmitted image or video stream). The complete image may then be provided to the display screen 108 for display to the user 110.

While the example computer-based device of FIG. 6 is configured to transmit drawing canvas events between parties of the video conference to activate changes to the drawing canvas using separate transmit and receive event channels that are separate from the channels used to transmit the images (e.g. video) of the parties, in other examples the computer-based device may be configured to embed the event information within the video channels (i.e. the channels used to transmit and receive images of the parties to the video conference). In either of these examples, event information describing actions to be performed on the drawing canvas are transmitted to all parties of the video conference and it is up to the party's local device to render or generate a drawing canvas that incorporates or implements the specified actions.

In other examples, the drawing canvas 502 may be generated by the transmitting computer-based device and then sent to the other parties as a separate encoded image. In yet other examples, the complete output image may be generated by the transmitting computer-based device and then sent to the other parties as a whole image. In these examples, the transmitting computer-based device generates or renders the drawing canvas based on the event information it receives from the content manager 604 and merges the generated or rendered drawing canvas with the transmitted images and/or the received images to generate a complete output image and transmits this complete output image to the other parties to the video conference. In either of these examples no event information is transmitted between the parties, instead either a rendered drawing canvas or a rendered complete image is transmitted between parties. These examples may be more suitable for non-collaborative drawings (e.g. when only one user is able to control the drawing canvas) since it is difficult to create a single real-time drawing canvas that incorporates changes made by more than one user.

While FIG. 6 shows the gesture detection and image processing being completed on a local computer-based device associated with the user 110, in other examples, one or more of the processes described herein may be performed by a cloud service. However, in such cases the cloud service would only be provided with the encoded images (i.e. video) instead of the raw images (e.g. video) generated by the capture device 102 which may reduce the quality of the image processing and rendering.

In some cases the computing-based device of FIG. 6 may also comprise a sound detection engine (not shown) that receives an audio signal representing audio detected by a microphone placed near the user. The sound detection engine analyses the received audio signal to detect predetermined sounds. If the sound detection engine detects one of the predetermined sounds it outputs information identifying the detected sound to the content manager 604. The content manager may use the information identifying a detected sound to (a) control the computing-based device based on this information alone; and/or (b) control the computing-based device based on this information and the information received from the object tracking and gesture recognition engine 212. For example, the content manager may use the sound information to help make a decision on whether an action should be taken in the drawing canvas in light of the information received from the object tracking and gesture recognition engine 212.

As described above, a video conference between two or more parties typically comprises at least two video or image streams. A first video or image stream provides an image or video of the user 110. The first video or image stream will also be referred to herein as the transmitted image or video stream. This first video or image stream is generated by an image capture device 102 local to the user and is transmitted from the user's computing-based device to the computing-devices of the other parties so they can see an image or video of the user.

A second video or image stream provides an image or video of the other party to the video conference. This second video or image stream is generated by an image capture device local to that party and is transmitted from a computing-based device local to that party to the user's computing-based device. The second video is displayed to user so they can see an image of the other party. There may be one second video or image stream for each remote party to the video conference. The second video will be also be referred to herein as the received image or video stream.

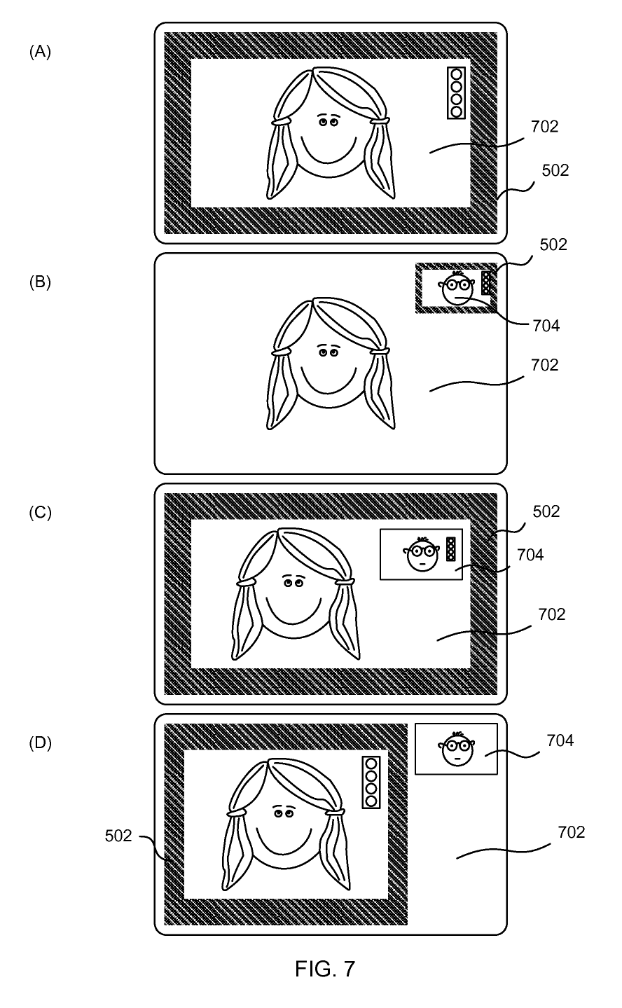

The drawing canvas 502 may be presented in front of one or more of the transmitted and received image or video streams. Reference is now made to FIG. 7 which illustrates example positions for the drawing canvas 502 with respect to the received and transmitted image or video streams 702 and 704. In some cases, as shown in FIG. 7A, the user is presented only with the received image or video stream 702 and the drawing canvas 502 is rendered in front of the entire received image or video stream 702.

In other cases, as shown, in FIGS. 7B-7C the user is shown both the received image or video stream 702 and the transmitted image or video stream 704. In these cases, the drawing canvas 502 may be rendered in front of the received video or image stream 702 only (not shown); in front of the entirety of the transmitted video or image stream 704 (FIG. 7B); in front of both the received image or video stream 702 and the transmitted image or video stream 704 (FIG. 7C); in front of part of the received image or video stream 702 (FIG. 7D); or in front of part of the transmitted image or video stream 704 (not shown). While FIGS. 7B to 7D illustrate the video streams 702 and 704 being presented so that the transmitted video or image stream 704 is seen in the upper right corner of the received video, the video streams 702 and 704 may be presented to the user in another suitable manner (e.g. side by side). Where the drawing canvas 502 is shown in front of the transmitted video or image stream 704 the effect produced by the drawing canvas 502 may be similar to drawing on and/or interacting with a physical mirror.

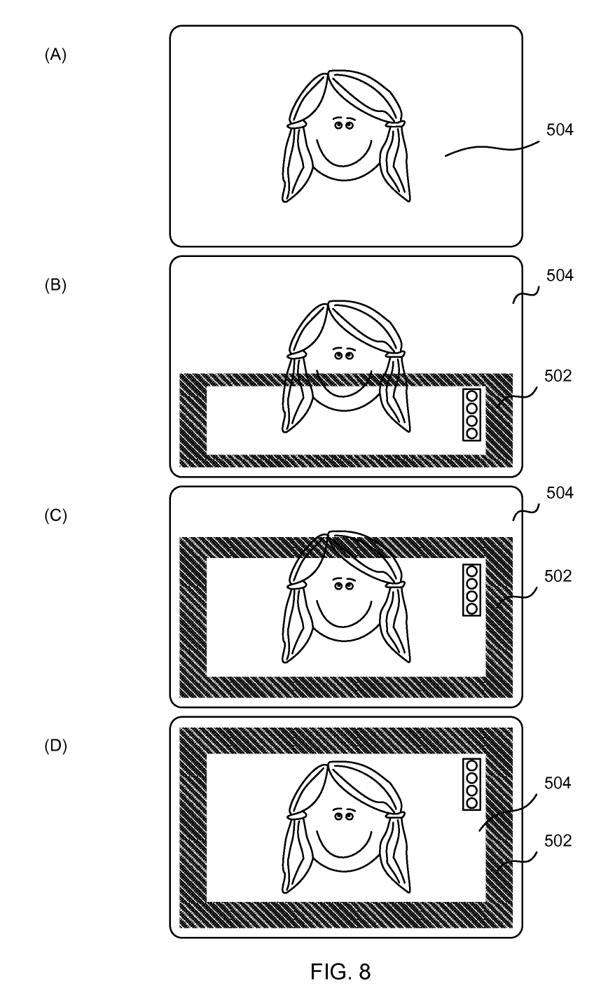

In some cases when the drawing canvas 502 is first activated by the user 110, the drawing canvas 502 may be animated (e.g. it may be configured to slide into place from one of the edges) to indicate to the user that the drawing canvas 502 has been activated. This is illustrated in FIG. 8 which shows a drawing canvas 502 appearing to slide into place from the bottom of the image 504. In other cases other animations may be used to signal activation of the drawing canvas 502. In some cases, a similar or related animation may be used upon deactivation of the drawing canvas. For example, the drawing canvas may be configured to appear to slide out to one of the edges (e.g. the bottom edge) once it has been deactivated by the user. The drawing canvas 502 may be activated and/or deactivated by a gesture performed by the user in the predetermined range 304 or by any other user input (e.g. keyboard/mouse input).

Once the drawing canvas 502 has been activated the user may use gestures to add drawing elements to, or edit drawing elements on, the drawing canvas 502. In some cases, the user may be able to add free form drawing elements by indicating they wish to start a free form drawing by making a start drawing gesture and/or providing such an indication through other input means. For example, the user may indicate that they wish to start a free form drawing by pressing a certain key on a keyboard (e.g. the space bar); making a gesture in the predetermined range 302 to press or select an element of the drawing canvas (e.g. selecting an element in the drawing toolbar); making a short distinct sound (e.g. a click); starting to make an elongated distinct sound (e.g. imitating the “psssh” sound of a spray paint air gun); making a tapping gesture in the predetermined range 302; or any combination thereof

Once the user has indicated that they wish to start a free form drawing they may use their finger to draw a shape. The system will track the user's finger (or a part thereof (e.g. fingertip)) and replicate the shape made with the user's finger on the drawing canvas 502.

The system may provide feedback to the user on the current location of their finger with respect to the drawing canvas. The particular feedback may be based on the relationship between the drawing canvas and the transmitted and received image or video streams. Where, as shown in FIG. 7B, the drawing canvas 502 is rendered on top of the transmitted image or video stream 704 then the feedback to the user may be the display of the user's finger on the drawing canvas. This allows the output display to act as a mirror allowing the user to see his/her own expression and movements.

Where, however, as shown in FIGS. 7A and 7C the drawing canvas 502 is rendered on top of the received image or video stream 702 then the system may be configured to visually indicate the current position of the user's finger with respect to the drawing canvas 502 by using a cursor or other object. Alternatively, the current position of the user's finger may be shown as a semi-transparent reflection onto the received image or video stream 702. To implement the semi-transparent reflection the system may be configured to segment the image elements of the received images that belong to the user's finger and have the rendered reflection focus on these image elements. Alternatively, the transparency of the reflection may be based on the distance to the fingertip drawing position. For example, the transparency may increase with the distance to the fingertip drawing position. In these cases where the drawing canvas is presented on top of the received image or video stream 702, the user gets to see the other party's reactions and expression in the same window as the drawing canvas.

Where the user has initiated a drawing by making an elongated distinct sound (e.g. the “psssh” sound of a spray paint air gun) changes to the elongated distinct sound whilst the sound is being generated by the user may change a characteristic of the drawing with live effect. For example, the tone/pitch and/or volume of the elongated distinct sound may be altered by the user. In this example, the sound alteration may affect the color, dimensions or opacity of the spray being rendered on the screen at that time. Specifically, increasing the volume of the generated elongated sound may produce an altered spray effect equivalent or similar to moving a spray can closer to a surface being sprayed.

Once the user has finished generating their free form drawing they may indicate the end of the free form drawing by making an end drawing gesture and/or providing such an indication through other input means. For example, the user may indicate they wish to end a free form drawing by pressing a certain key on the keyboard (e.g. the space bar); making a gesture in the predetermined range 304 to press or select an element of the drawing canvas (e.g. selecting an element in the drawing toolbar); making a short distinct sound (e.g. a click); ending the elongated distinct sound (e.g. the “psssh” sound of a spray paint air gun); making a gesture to lift their finger in the predetermined range 304; or any combination thereof.

In some cases, the user may also be able to add pre-drawn shapes to the drawing canvas 502. The pre-drawn shapes may be selected from a menu, toolbar or other selection tool that is activated by performing a predetermined gesture in the predetermined range and/or providing a certain input via other input means (e.g. pressing a key on a keyboard, or making a specific sound). A selection from the activated selection tool may similarly be made by executing a predetermined gesture in the predetermined range and/or providing a certain input via other input means. The pre-drawn shapes may include basic geometric shapes such as circles, rectangles and triangles and/or more complicated shapes.

In some cases, the user may adjust features (e.g. color, line thickness) of a drawing element (e.g. free-form drawing or pre-drawn shape) before and/or after the drawing element has been created in or added to the drawing canvas 502. For example, the features may be selected from a menu, toolbar or other selection tool that is activated by performing a predetermined gesture in the predetermined range and/or providing a certain input via other input means (e.g. pressing a key on a keyboard, or making a specific sound). A selection from the activated selection tool may similarly be made by executing a predetermined gesture in the predetermined range and/or providing a certain input via other input means. The selection tool that allows adjustment of the feature of a drawing element may be the same selection tool or a different selection tool as the selection tool used to add pre-drawn shapes to the drawing canvas 502.

In some cases, the user may be able to manipulate the drawing elements within the drawing canvas 502 or the drawing canvas 502 itself by executing certain gestures in the predetermined range. For example, the user may be able to move a drawing element (e.g. a free-form drawing or pre-drawn shape) by making a pointing gesture at the drawing element and then moving their finger to the new location for the drawing element. The user may also be able zoom in or out on an area of the drawing canvas 502 by executing a pinching gesture or an expanding gesture within the predetermined range respectively. The user may also pan or scroll the content of the drawing canvas 502 by executing a grabbing or pointing gesture within the predetermined range. In some cases the drawing canvas 502 may be conceptually larger than the limits of the window in which the image or video stream behind the drawing canvas is displayed (e.g. the window in which the received image or video stream 702 is displayed). In these cases manipulation gestures such as zooming and panning may be used to determine which portion of the drawing canvas 502 is currently displayed.

Alternatively, or in addition, the user may be able to manipulate (e.g. move, zoon, pan or scroll) drawing elements or the drawing canvas 502 by selecting a manipulation tool from a menu, toolbar or other selection tool that is activated by performing a predetermined gesture in the predetermined range and/or providing a certain input via other input means (e.g. pressing a key on a keyboard, or making a specific sound). A selection from the activated selection tool may similarly be made by executing a predetermined gesture in the predetermined range and/or providing a certain input via other input means.

In some cases the user may be able to remove all or part of a drawing element (e.g. free form drawing or pre-drawn shape) in the drawing canvas 502 by waving their hand over all or part of the drawing element.

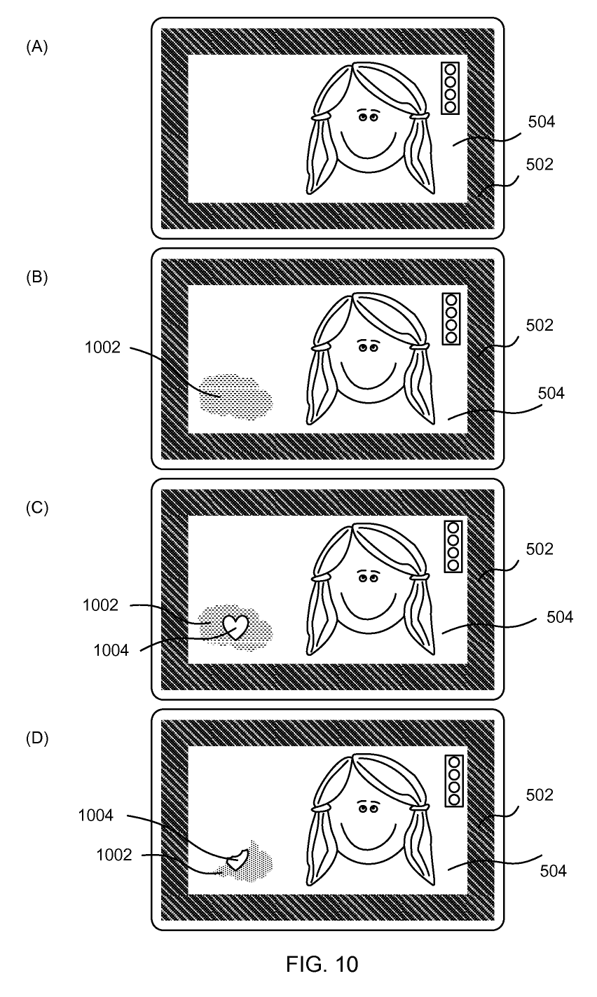

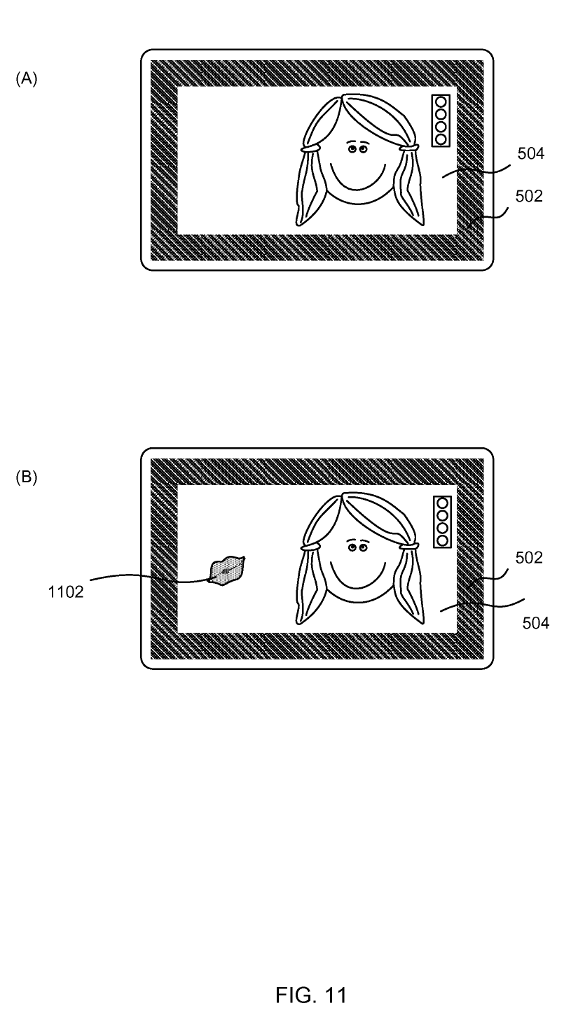

Examples of adding and editing drawing elements on the drawing canvas 502 are illustrated in FIG. 9. In particular, FIG. 9A shows a free form drawing element (e.g. sun) 902 that has been added to the drawing canvas 502; FIG. 9B shows a pre-drawn object (e.g. rectangle) 904 that has been added to the drawing canvas 502; and FIG. 9C shows the pre-drawn object 904 after it has been moved to a different location in the drawing canvas 502.

Where the drawing canvas 502 is designed to act as a window between the parties of the video conference, the system may be configured to produce window-like effects on the drawing canvas 502 when the user 110 performs certain gestures in the predetermined range 304. Example effects are described with reference to FIGS. 10 and 11. In particular, FIG. 10 illustrates a condensation effect. FIG. 10A illustrates a drawing canvas 502 positioned over an image or video 504. The image or video 504 may be the received image or video or the transmitted image or video as describe above. When the user initiates a certain gesture, for example, they make a blowing gesture with their mouth and/or face within the predetermined range 304 the system may be configured to render a semi-transparent cloud of condensation 1002 on the drawing canvas (FIG. 10B). The direction and force of the blowing may be used to control the position and intensity of the condensation 1002. In some examples, the condensation may also or alternatively be triggered by other gestures, such as, the user executing a gesture to place the palm of their hand on the drawing canvas 502. In the cases where the condensation is triggered by such a gesture, the condensation may be formed in the shape of an outline around the user's hand.

In some cases the condensation 1002 may provide a temporary drawing area for the user. For example, the user may be able to, through gestures made within the predetermined range 304, make drawings in the condensation in a similar way that a user may use their finger to draw a shape in condensation in a real window. For example, as shown in FIG. 10C, the user may draw a shape (e.g. heart) with their finger which results in the shape (e.g. heart) 1004 being drawn in the condensation (i.e. part of the condensation 1002 is removed to reveal the shape). The shape 1004 may be rendered in the condensation 1002 so that it appears as if has been drawn by a user in actual condensation.

The system may be configured to render the condensation 1002 so that it appears to gradually fade away in the same manner as real condensation would. FIG. 10D shows the condensation 1002 and object in the condensation (e.g. heart) 1004 after it has been partially faded away. The system may be configured to gradually fade away the condensation 1002 and any shape 1004 therein within a predetermined period. The predetermined period may be fixed or may be dynamically selected. For example, in some cases the predetermined period may be based on the estimated force of the blowing. In other cases the predetermined period may be based on the outside temperature and/or humidity. The outside temperate and/or humidity information may be known or may be obtained using information about the location of the user.

FIG. 11 illustrates another example window-like effect. In particular FIG. 11 illustrates a kiss effect. FIG. 11A illustrates a drawing canvas 502 positioned over an image or video 504. The image or video 504 may be the received image or video or the transmitted image or video as describe above. When the user initiates a certain gesture, for example, they make a kissing gesture with their mouth and/or face within the predetermined range 304 the system may be configured to render an image of lips 1102 on the drawing canvas 502 (FIG. 11B). The lip image may, for example, be rendered to look like lipstick or moisture (e.g. condensation).

Where the drawing canvas 502 is designed to act as a window between the parties of the video conference, the system may be configured to implement one or more of the following effects to enhance the illusion of a real window.

In particular, the system may be configured to produce certain sounds in response to certain gestures being performed in the predetermined range to further simulate a real window. For example, in some cases the system may be configured to generate a knocking sound or a tapping sound when the system detects a knocking gesture or a tapping gesture within the predetermined range.

The system may also be configured to enhance the illusion by rendering static or dynamic semi-transparent reflections in the drawing canvas 502. For example, the system may be configured to render a semi-transparent reflection of the user onto the drawing canvas 502. In these examples the system may be configured to focus on the bright and high contrast details when rendering the reflection in order not to obscure the image or video 504 behind the drawing canvas 502.

The system may also be configured to use the position of the user's face to control a small positional parallax offset between the image or video stream 504 (e.g. the received image or video stream 702) displayed behind the drawing canvas 502 and the drawing canvas 502. For example, the user's face may be tracked using the tracking and gesture recognition engine 212 and used to adjust the perceived three dimensional distance between the drawing canvas 502 and the image or video stream 504 behind the drawing canvas. This creates an effect whereby the position or direction of the drawing canvas 502 appears to change as the user moves their face. When the other user is drawing on the drawing canvas 502 the offset may be visible as a distance between the other user's finger and the drawing element. To avoid this effect, the offset may be reset while a user is drawing on the drawing canvas 502.

The system may also allow the user to record, save and/or reuse the content of the drawing canvas. For example, the system may allow the user to do one or more of the following: record the rendered video stream (either the video stream comprising the user image combined with the rendered drawing canvas or the video stream comprising only the rendered drawing canvas); print still images of the content in the drawing canvas (with or without the background image); save still images of the drawing canvas as part of a video communication summary or artifact; scale and package the content in the drawing canvas into a personalized card and sending to another user; display the content in the drawing canvas 502 on a non-transparent background and, copy the content in the drawing canvas 502 for reuse in other applications.

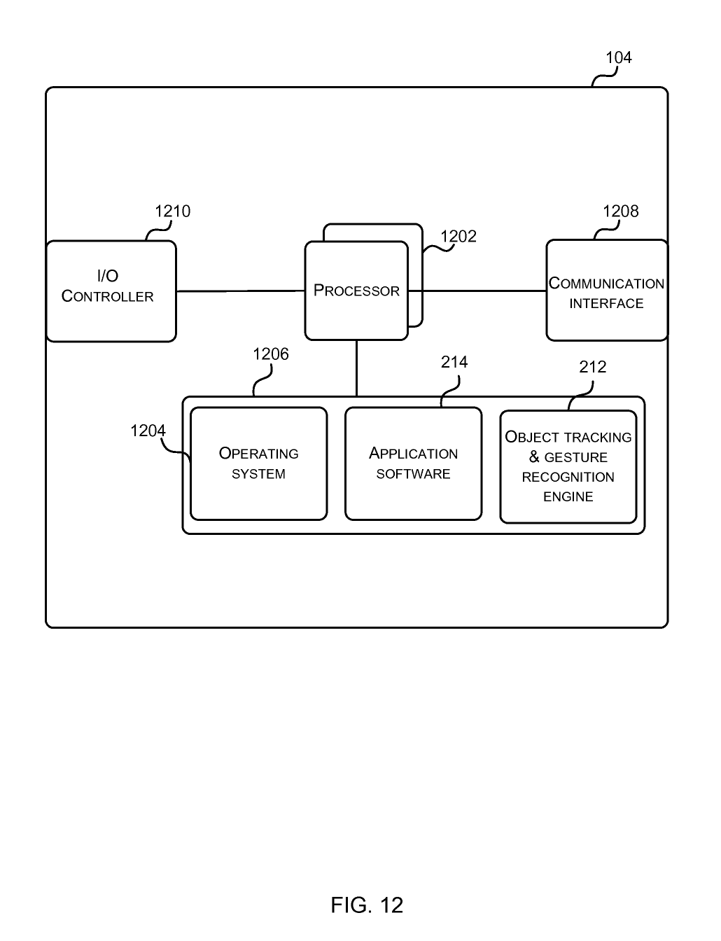

FIG. 12 illustrates various components of an exemplary computing-based device 104 which may be implemented as any form of a computing and/or electronic device, and in which embodiments of the systems and methods described herein may be implemented.

Computing-based device 104 comprises one or more processors 1202 which may be microprocessors, controllers or any other suitable type of processors for processing computer executable instructions to control the operation of the device in order to detect hand gestures performed by the user and to control the operation of the device based on the detected gestures. In some examples, for example where a system on a chip architecture is used, the processors 1202 may include one or more fixed function blocks (also referred to as accelerators) which implement a part of the method of controlling the computing-based device in hardware (rather than software or firmware). Platform software comprising an operating system 1204 or any other suitable platform software may be provided at the computing-based device to enable application software 214 to be executed on the device.

The computer executable instructions may be provided using any computer-readable media that is accessible by computing based device 104. Computer-readable media may include, for example, computer storage media such as memory 1206 and communications media. Computer storage media, such as memory 1206, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing-based device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 1206) is shown within the computing-based device 104 it will be appreciated that the storage may be distributed or located remotely and accessed via a network or other communication link (e.g. using communication interface 1208).

The computing-based device 104 also comprises an input/output controller 1210 arranged to output display information to a display device 108 (FIG. 1) which may be separate from or integral to the computing-based device 104. The display information may provide a graphical user interface. The input/output controller 1210 is also arranged to receive and process input from one or more devices, such as a user input device (e.g. a mouse, keyboard, camera, microphone or other sensor). In some examples the user input device may detect voice input, user gestures or other user actions and may provide a natural user interface (NUI). In an embodiment the display device 108 may also act as the user input device if it is a touch sensitive display device. The input/output controller 1210 may also output data to devices other than the display device, e.g. a locally connected printing device (not shown in FIG. 12).

The input/output controller 1210, display device 108 and optionally the user input device may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs) and Graphics Processing Units (GPUs).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method of controlling a computing-based device, the method comprising:
receiving, at a processor, an image stream of a scene from a capture device;
analyzing the image stream to identify one or more objects in the scene that are within a predetermined range of the capture device, the predetermined range being a subset of the field of view of the capture device, the subset being spaced from the capture device;
tracking the one or more identified objects to identify one or more gestures performed by the one or more identified objects; and
controlling the computing-based device using the one or more identified gestures.

2. The method of claim 1, wherein the one or more identified gestures are used to control a video conferencing application running on the computing-based device.

3. The method of claim 2, wherein the scene comprises a user of the video conferencing application and the method further comprises transmitting the image stream to another party of a video conference to which the user is party.

4. The method of claim 1, wherein the predetermined range is a three-dimensional volume.

5. The method of claim 4, wherein the three-dimensional volume is not rectangular.

6. The method of claim 1, wherein the one or more identified gestures are used to control one or both of: a drawing application running on the computing-based device;
an operating system running on the computing-based device.

7. The method claim 6, further comprising receiving an audio stream; analyzing the audio stream to identify one or more predetermined sounds; and controlling the drawing application using the one or more identified gestures and the one or more identified sounds.

8. The method of claim 7, wherein the one or more predetermined sounds are used to initiate a drawing in the drawing application.

9. The method of claim 6, wherein the one or more objects comprise a user's finger and the method further comprises displaying a visual indication of the current location of the user's finger on a drawing canvas of the drawing application.

10. The method of claim 9, wherein the visual indication of the current location of the user's finger is one or both of: a computer generated reflection of the user's finger; displayed on the drawing canvas of the drawing application when the user's finger is within the predetermined range.

11. The method of claim 6, wherein the one or more objects comprise a user's face and the tracking of the user's face enables identification of a blowing gesture.

12. The method of claim 11, wherein the identification of the blowing gesture causes a condensation effect to be displayed on a drawing canvas of the drawing application.

13. The method of claim 12, wherein the condensation effect provides a temporary drawing area within the drawing canvas that is displayed for a predetermined period.

14. The method of claim 1, further comprising determining a speed at which a particular identified object has entered the predetermined range; and, in response to determining the entry speed exceeds a first predetermined threshold, ignoring any gestures performed by the particular identified object until the speed of the particular identified object falls below a second predetermined threshold .

15. The method of claim 1, wherein the one or more objects comprise one or more of a user's finger, a user's hand and a user's face.

16. The method of claim 1, further comprising ignoring gestures performed by objects within the field of view and outside of the predetermined range.

17. The method of claim 1, further comprising tracking the one or more identified objects to identify the location of the one or more identified objects within the predetermined range; and controlling the computing-based device using the one or more identified gestures and the identified locations.

18. A system to process an image stream, the system comprising a computing-based device configured to:
receive an image stream of a scene from a capture device;
analyze the image stream to identify one or more objects in the scene that are within a predetermined range of the capture device, the predetermined range being a subset of the field of view of the capture device, the subset being spaced from the capture device;
track the one or more identified objects to identify one or more gestures performed by the one or more identified objects; and
control the computing-based device using the one or more identified gestures.

19. The system of claim 18, the computing-based device being at least partially implemented using hardware logic selected from any one or more of: a field-programmable gate array, a program-specific integrated circuit, a program-specific standard product, a system-on-a-chip, a complex programmable logic device.

20. A method of controlling a computing-based device, the method comprising:
receiving, at a processor, an image stream of a scene from a capture device;
analyzing the image stream to identify one or more objects in the scene that are within a predetermined range of the capture device, the predetermined range being a subset of the field of view of the capture device, the subset being spaced from the capture device;
tracking the one or more identified objects to identify one or more gestures performed by the one or more identified objects; and
controlling a drawing canvas in a video conference session running on the computing-based device using the one or more identified gestures.
